(19) United States
(12) Patent Application Publication
(10) Pub. No.: US 2016/0113255 A1
(43) Pub. Date: Apr. 28, 2016

(54) No Foul Nose Pin Hook

(71) Applicant: John Lofton Mason, JR., Brasstown, NC (US)

(72) Inventor: John Lofton Mason, JR., Brasstown, NC (US)

(21) Appl. No.: 14/982,053

(22) Filed: Dec. 29, 2015

(51) Int. Cl. A01K 83/06

(52) U.S. Cl. CPC A01K 83/06

(57) ABSTRACT

A fishhook for nose pinning live bait so that the bait cannot get themselves foul hooked on the point of the hook. This is accomplished by placing a stationary ball near the middle of the bend of the hook slightly towards the eye, which can be molded, tied or adhered in a fashion that the ball cannot move.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A SEQUENCE LISTING, A TABLE, OR A COMPUTER PROGRAM LISTING COMPACT DISC APPENDIX

Not applicable.

### BACKGROUND OF THE INVENTION

This invention pertains to the activity or sport of fishing. This invention arose out of live bait being foul hooked on themselves causing the fisherman to loose fish that would strike at the bait.

### BRIEF SUMMARY OF THE INVENTION

This invention is a fishhook with an attached ball, molded, tied or adhered to the bend of the fishhook to prevent live bait from sliding past the bend onto the throat or shank of the hook. The addition of the ball allows the live bait to swim freely without foul hooking itself in some part of its body by the fishhook's point. The size of the ball depends on the size of the hook and the size of the desired bait used.

### BRIEF DESCRIPTION OF THE DRAWING

FIG. 1, shows a standard fishhook and labels its parts. Parts contain the eye, shank, throat, ball, bend, barb, point, and gap. FIG. 1 shows the relative placement of the ball in order not to foul hook a nose pinned bait.

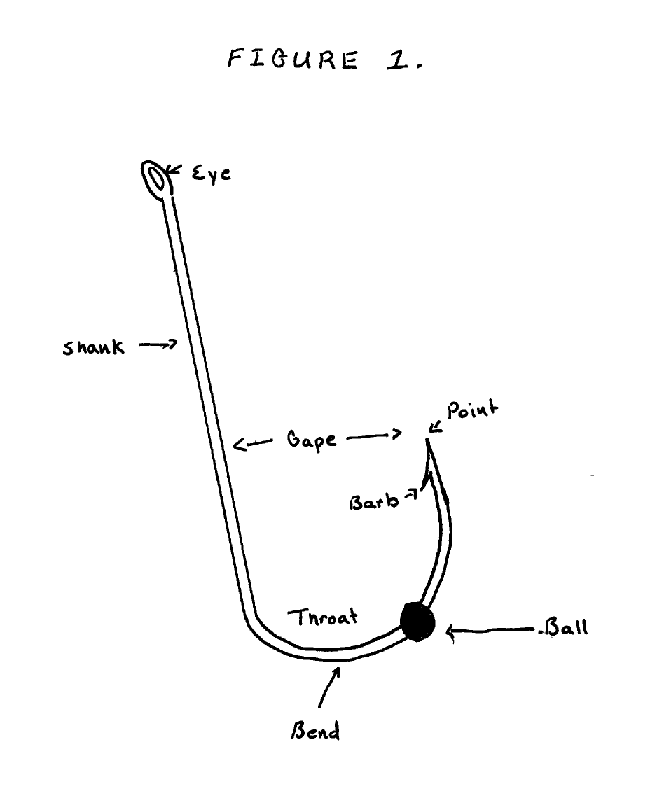

### DETAILED DESCRIPTION OF THE INVENTION

This is an improvement on any type of fishhook that a fisherman chooses to use to nose pin live bait. The placement of a ball in the middle of the bend but slightly toward the barb will stop live bait from foul hooking itself and causing a fisherman to miss a strike from the target fish. The size of the ball will vary by the size of the hook and the desired bait. This can be tailored to the specifications of certain baits and hooks but in general the size of the ball should be four times the diameter of the hook on which the ball is placed, this size will be sufficient for most baits a fisherman will use. This ball must be molded in the hook, tied on to the hook, or adhered to the hook in a fashion where the ball will not move where it is placed. The ball being stationary is critical to the usefulness of not foul hooking the live bait used. If the ball is mobile the live bait is mobile and then the live bait can foul hook itself. When the ball is stationary in the middle of the bend but slightly towards the eye the bait is only mobile between the ball and the barb, eliminating the live bait from foul hooking itself.

Having described the invention I claim:

1. This invention is distinct from other fishhooks by the placement of a stationary ball in the middle of the bend of the hook slightly toward the eye which allows a fisherman to use a nose pinned live bait without having to worry about that bait foul hooking itself.
